(19) United States
(12) Patent Application Publication
(10) Pub. No.: US 2011/0063078 A1
(43) Pub. Date: Mar. 17, 2011

(54) COMMUNICATION SYSTEM, OPERATION CONFIRMATION PROCESSING METHOD AND OPERATION CONFIRMATION PROCESSING PROGRAM FOR COMMUNICATION SYSTEM

(75) Inventor: Akihiro Souma, Shizuoka-ken (JP)

(73) Assignee: TOSHIBA TEC KABUSHIKI KAISHA, Tokyo (JP)

(21) Appl. No.: 12/721,209

(22) Filed: Mar. 10, 2010

(30) Foreign Application Priority Data
Sep. 14, 2009 (JP) 2009-212290
Sep. 15, 2009 (JP) 2009-213675

(51) Int. Cl. H04Q 5/22

(52) U.S. Cl. 340/10.1

(57) ABSTRACT

The invention provides a technique that makes it possible to surely detect an abnormality in normal operation of an antenna of a communication system for wireless communication with an RF tag attached to a management target article. The antenna is provided with an operation confirmation RF tag with which the antenna can always establish wireless communications when normally transmitting to the attached RF tag. The communication system transmits, from the antenna, radio waves for wireless communication with the RF tag attached to the management target article, and thus can determine an abnormality of the antenna on the basis of the presence or absence of a response from the operation confirmation RF tag.

### CROSS REFERENCE TO RELATED APPLICATION

This application is based upon and claims the benefit of priority from the prior Japanese Patent Application No. 2009-212290, filed on Sep. 14, 2009, the entire contents of which are incorporated herein by reference.

### FIELD OF THE INVENTION

The invention relates to a communication system to detect an RF (Radio Frequency) tag. In particular, the invention relates to a communication system to detect that trouble occurs in an antenna of the communication system, and also to an operation confirmation processing method and an operation confirmation processing program for the communication system.

### DESCRIPTION OF THE BACKGROUND

Japanese Patent Application Publication P2008-299364(A1) discloses an inspection apparatus to determine whether or not a problem occurs in a communication state between an RF tag and a reader/writer for performing a process of reading the RF tag. The inspection apparatus of this kind is capable of specifying a cause of a problem when the problem occurs in the communication state.

In order to detect whether or not an antenna operates normally, however, the technique disclosed in Japanese Patent Application Publication P2008-299364(A1) requires new installation of the inspection apparatus of this kind in addition to the reader/writer. Moreover, when the reader/writer fails in the RF tag reading process, the reader/writer alone cannot identify which one of factors causes the reading process failure, one of the factors being non-existence of RF tags within a wireless communication coverage area of the antenna of the reader/writer, and the other of factors being a failure in the antenna of the reader/writer, itself.

The invention has been made to solve the aforementioned problems, and an object of the invention is to provide a technique that makes it possible to surely detect that an antenna of a communication system for wirelessly communicating with an RF tag does not operate normally.

### SUMMARY OF THE INVENTION

In order to solve the aforementioned problems, an aspect of the invention provides a communication system including an antenna which transmits and receives radio waves for wirelessly communicating with an RF tag attached to a management target article, and which is provided with an operation confirmation RF tag with which wireless communications are always established in a case where the radio waves are normally transmitted.

An aspect of the invention relates to a communication system including: an antenna configured to transmit and receive radio waves for wireless communication with an first RF tag attached to a management target article; an second RF tag disposed within a communication coverage area in a state of being allowed to communicate with the antenna; a transmitter configured to transmit a read signal for reading information of the RF tag to the first and the second RF tags via the antenna; and a determination unit configured to determine a malfunction of the antenna, when not receiving the reply signal from the first RF tag and second RF tag in response to the read signal.

An aspect of the invention relates to a communication system including: an antenna configured to transmit and receive radio waves for wireless communication with an first RF tag attached to a management target article; an second RF tag having unique ID information disposed within a communication coverage area in a state of being allowed to communicate with the antenna; a transmitter configured to transmit a read signal for reading information of the RF tag to the first and second RF tags via the antenna; and a determination unit configured to determine a malfunction of the antenna, when the antenna does not received the unique ID information from the second RF tag in response to the read signal.

An aspect of the invention relates to an operation confirmation processing method for a communication system including: an RF tag attached to a management target article; and an antenna configured to transmit and receive radio waves for wireless communication with the RF tag. The method includes: transmitting a read signal for reading information of the RF tag to the first RF tag and an second RF tag via the antenna, the second RF tag is attached to the area which can communicate with the antenna; and determining the antenna malfunction, in a case where no response signal is received from the RF tags in response to the read signal.

An aspect of the invention relates to an operation confirmation processing method for a communication system including: an RF tag attached to a management target article; and an antenna configured to transmit and receive radio waves for wireless communication with the RF tag. The method includes: transmitting a read signal for reading information of the RF tag to the first RF tag and an second RF tag via the antenna, the second RF tag having unique ID information attached to the area which can communicate with the antenna; and determining the antenna malfunction, when the antenna does not received the unique ID information from the second RF tag in response to the read signal.

An aspect of the invention relates to an operation confirmation processing method for a communication system including: an RF tag attached to a management target article; and an antenna configured to transmit and receive radio waves for wireless communication with the RF tag. The method includes: transmitting a read signal for reading information of the RF tag to the RF tag and an plurality of operation confirmation RF tags via the plurality of antennas, the plurality of second RF tags each having unique ID information attached to the plurality areas which can communicate with corresponding to the plurality of the antenna; and determining antenna malfunction, when the plurality of antennas does not received the plurality unique ID information from at least the second RF tags in response to the read signal.

The invention can provide a technique that makes it possible to surely detect that an antenna of a communication system for wireless communication with an RF tag does not operate normally.

### BRIEF DESCRIPTION OF THE DRAWINGS

FIG. 1 is a system configuration diagram to describe a configuration of a reader/writer as a communication system for reading information written on an RF (Radio Frequency) tag or the like according to a first embodiment.

FIG. 2 is a block diagram of functions implemented by the reader/writer of the first embodiment.

FIG. 3 is a flowchart showing an operation confirmation process for an antenna, which is executed by the reader/writer of the first embodiment.

FIG. 4 is a functional block diagram to describe functions of a reader/writer of a second embodiment.

FIG. 5 is a flowchart showing an operation confirmation process for an antenna, which is executed by the reader/writer of the second embodiment.

FIG. 6 is a system diagram showing a configuration of a reader/writer of an third embodiment.

FIG. 7 is a flowchart showing an operation confirmation process for an antenna, which is executed by the reader/writer of the third embodiment.

### DETAILED DESCRIPTION OF THE INVENTION

Hereinafter, the embodiments of the invention will be described with reference to the drawings.

### First Embodiment

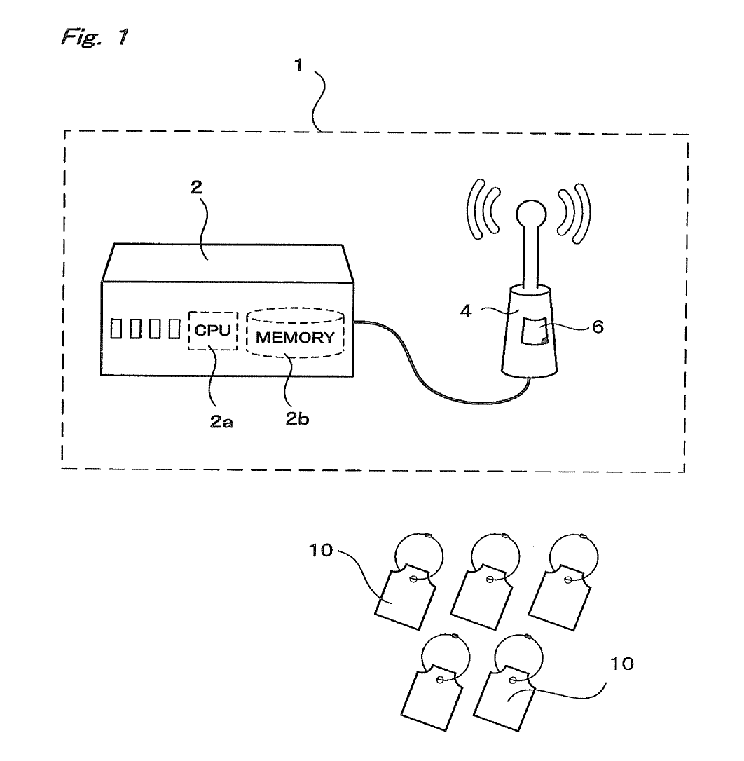

FIG. 1 is a system configuration diagram to describe a configuration of a reader/writer 1 as a communication system for reading information written on an RF (Radio Frequency) tag or the like according to the first embodiment.

The reader/writer 1 is an apparatus for wirelessly communicating with an RF tag 10 attached to a management target article, which exists in an area where an RF tag can be read (hereinafter, referred to as a “readable area”) in the field of what is termed as the RFID technique. In addition, the reader/writer 1 is an apparatus for performing a process of recognizing the presence of the RF tag 10 by reading information of the RF tag 10 and a process of writing information to the RF tag 10. The reader/writer 10 of the first embodiment is characterized by its capability to detect whether or not an antenna 4 operates normally and to then notify a user of the detection result.

A wireless system of the first embodiment emits radio waves to the RF tag 10 from the antenna 4. Then, a predetermined process is performed in the RF tag 10 by using the information communicated via the radio waves. Moreover, the wireless system of the first embodiment is a radio wave-type system for performing a reading process by receiving radio waves which are reflected off the RF tag 10.

The RF tag 10 is a so-called passive tag configured to receive radio waves transmitted from the reader/writer 1. Then, the RF tag 10 performs a predetermined process by using the radio waves received by an IC chip included in the RF tag 10, and to transmit reflected radio waves on which ID information or the like is superimposed.

Hereinafter, devices and members that constitute the reader/writer 1 according to the first embodiment will be described.

As shown in FIG. 1, the reader/writer 1 includes a controller 2, the antenna 4, an operation confirmation RF tag 6 and the management target article RF tag 10. The controller 2 controls the process of reading an RF tag. The antenna 4 transmits and receives radio waves to and from an RF tag. The operation confirmation RF tag 6 is used to confirm the operation of the antenna 4.

To begin with, the controller 2 is a processor for reading information written on the RF tags 6, 10 and writing information to the RF tag 10, via the antenna 4. The controller 2 is provided with a CPU 2a, a memory 2b and the like.

The CPU 2a executes various processes in the controller 2. In addition, the CPU 2a executes various processes such as the process of reading the RF tags 6, 10 and the operation confirmation process for the antenna 4 by executing various programs stored in the memory 2b.

The memory 2b stores programs such as a program for the reading process to be executed by the aforementioned CPU 2a. The memory 2b is configured of a RAM (Random Access Memory), a ROM (Read Only Memory), a DRAM (Dynamic Random Access Memory), an SRAM (Static Random Access Memory), a VRAM (Video RAM) or the like.

With the aforementioned configuration, the controller 2 transmits a read signal for performing the process of reading the RF tags 6, 10 and a write signal for performing the process of writing to the RF tag 10 to the antenna 4 connected to the controller 2. In addition, the controller 2 is capable of acquiring signals which are included in the radio waves received by the antenna 4. Furthermore, the controller 2 is capable of executing an operation confirmation process for notifying that the antenna 4 does not operate normally, in a case where the controller 2 cannot detect any one piece of RF tag information even when a read signal (or write signal) of an RF tag is transmitted. The operation confirmation process for the antenna 4 will be described later in detail.

Note that, the controller 2 is provided with a display unit, an operation input unit and the like in addition to the aforementioned components, and causes the display unit to display the information on the process of reading the RF tags 6, 10, and the information on the operation confirmation process for the antenna 4. In addition, various operation inputs such as setting inputs for various processes can be made with the controller 2. The controller 2 may further include, for example, a dedicated alarm lamp, a alarm buzzer or the like in addition to the aforementioned display unit, in order to give notice of the result of the operation confirmation process.

In addition, the controller 2 is capable of connecting to an host system. The controller transmits the information of the RF tag 10 the information on the operation confirmation process for the antenna 4, and the like, which have been read, to an host computer, for example. The controller 2 is capable of acquiring information on setup of various processes, and the like, from the host computer, and of thus performing the various processes on the basis of the information.

Next, the antenna 4 transmits radio waves to the RF tags 6, 10 on the basis of signals from the controller 2, and receives reflected radio waves from the RF tags 6, 10 existing in the readable area. The antenna 4 may be of any system as long as the antenna 4 is capable of wireless communication with the RF tags 6, 10. Various types of antennas such as a whip antenna, a loop antenna, a patch antenna and an array antenna may be used, for example.

Then, the antenna 4 of the first embodiment is provided with the operation confirmation RF tag 6 for performing the operation confirmation process. The operation confirmation RF tag 6 is an RF tag for confirming whether or not the antenna 4 operates normally, transmits radio waves and receives radio waves from the RF tag 10. The operation confirmation RF tag 6 is disposed so that the operation confirmation RF tag 6 can always receive radio waves when the antenna 4 normally operates, and radio waves are transmitted from the antenna 4. In other words, when the radio waves for reading the RF tag 10 are transmitted from the antenna 4, the operation confirmation RF tag 6 always receives the radio waves and then transmits reflected radio waves to the antenna 4. The operation confirmation RF tag 6 is disposed with the antenna 4 being made capable of surely receiving the reflected radio waves. Specifically, the operation confirmation RF tag 6 is disposed in the readable area of the antenna 4 and in a place where there is no possibility that the radio waves of radio communications with the antenna 4 are not blocked. In a case where the radio waves to be emitted have a specific polarized wave direction, the operation confirmation RF tag 6 is disposed in a predetermined posture and positional relationship that allow the RF tag 6 to receive the radio waves.

Since the antenna 4 is provided with the operation confirmation RF tag 6, upon transmission of a read signal of the RF tags 6, 10 from the controller 2, the controller 2 can acquire a signal (hereinafter, referred to as a “response signal”) on the reflected radio waves from the operation confirmation RF tag 6 regardless of whether or not the RF tag 10 exists, as long as the antenna 4 operates normally. Accordingly, the controller 2 can always detect the operation confirmation RF tag 6. Thus, when the controller 2 cannot receive the response signal from any of the RF tags 6, 10 in a predetermined length of time, for example, after the controller 2 transmits the read signal, the controller 2 can determine a malfunction of the antenna 4. Specifically, when the number of received response signals is “0,” this means that the controller 2 does not receive the signal from the operation confirmation RF tag 6 either. Accordingly, the controller 2 can determine that trouble occurs in the antenna 4.

On the other hand, when the antenna 4 operates normally, the controller 2 can always receive the response signal from the operation confirmation RF tag 6. For example, even in a case where no RF tag 10 exists in the readable area, the controller 2 can receive one response signal from the operation confirmation RF tag 6. In addition, in a case where one or more RF tags 10 exist, the controller 2 can receive the response signals from the RF tags 10 and the response signal from the operation confirmation RF tag 6. Specifically, the controller 2 can always receive at least one response signal when the antenna 4 operates normally, so that the controller 2 can determine that the antenna 4 operates normally.

The operation confirmation RF tag 6 is provided with an IC chip and an antenna for receiving radio waves. Upon receipt of radio waves from the antenna 4, the operation confirmation RF tag 6 performs a predetermined process in the IC chip by using the radio waves, and thus can transmit reflected radio waves on which ID information and the like are superimposed. Note that, as the operation confirmation RF tag 6, one that is the same as the normal article management RF tag 10 may be used, or a dedicated RF tag having a specific shape, configuration or the like may be used.

Here, what can be confirmed on the operation of the antenna 4 by use of the operation confirmation RF tag 6 is whether or not radio waves are normally emitted from the antenna 4. For example, in a case where no radio waves are emitted because the antenna 4 is damaged, or in a case where no radio waves are emitted because of failure in connection between the antenna 4 and the controller 2, the controller 2 cannot receive the response signal from the operation confirmation RF tag 6. The controller 2 can thus determine that the antenna 4 does not operate normally in this case.

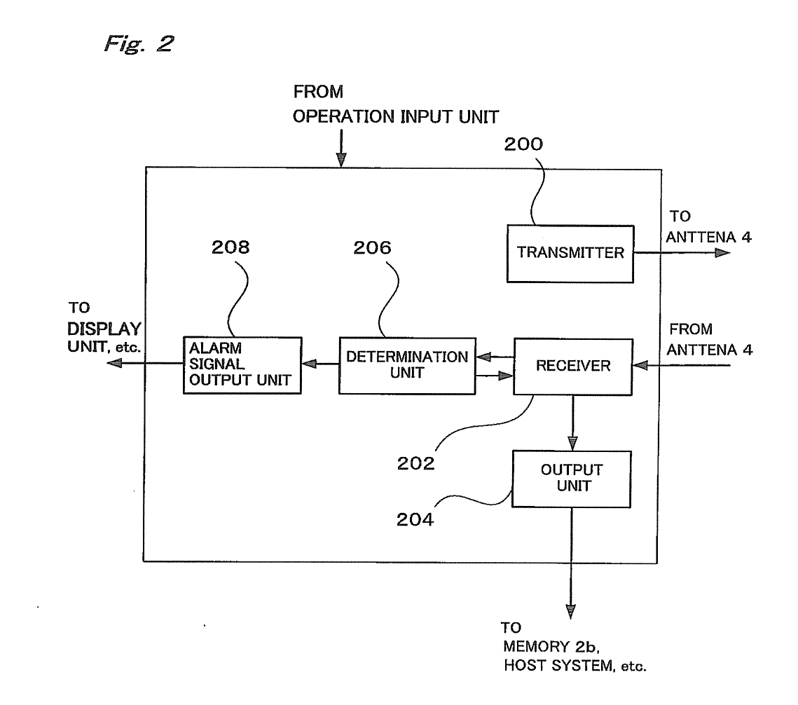

Next, with reference to FIG. 2, descriptions will be given of the operations of functional blocks for the reader/writer 1 of the first embodiment to execute the operation confirmation processing of determining whether or not the antenna 4 operates normally. FIG. 2 is a block diagram of the functions implemented by the reader/writer 1 of the first embodiment. The controller 2 includes a transmitter 200, a receiver 202, an output unit 204, a determination unit 206 and a alarm signal output unit 208.

Hereinafter, the functions constituting the reader/writer 1 of the first embodiment will be described.

The transmitter 200 outputs a read signal for reading the RF tags 6, 10 to the antenna 4 on the basis of an input from the operation input unit of the controller 2 of the reader/writer 1, or on the basis of a previously set predetermined timing.

When operating normally, the antenna 4 emits the radio waves of a reading signal to each of the RF tags 6 and 10. The emitted radio waves are received by the operation confirmation RF tag 6, and the RF tag 10 existing in the readable area. Then, reflected radio waves are transmitted from each of the RF tags 6, 10, and then received by the antenna 4.

The receiver 202 receives the reflected radio waves which, as the response signals, are received by the antenna 4.

The output unit 204 acquires the response signal which is received by the receiver 202, and then stores the information such as the ID information of the RF tags 6, 10, which is included in the response signals, in the memory 2b of the reader/writer 1. Moreover, the aforementioned information is transmitted to a computer or the like constituting the host system.

The determination unit 206 determines whether or not the receiver 202 receives one or more response signals from the RF tags 6, 10 in a previously set predetermined length of time. For example, when it reads in the antenna 4 to the RF tags 6, 10 and the electric wave of a signal cannot be transmitted by the abnormalities of the antenna 4, the receiver 202 cannot receive a response signal. Accordingly, after the predetermined length of time passes, the determination unit 206 determines that the antenna 4 does not operate normally.

When receiving a signal indicating an abnormality of the antenna 4 from the determination unit 206, the alarm signal output unit 208 outputs a signal for giving notice of the abnormality, i.e., to cause the display unit to display the abnormality. In addition, in a case where the controller 2 is provided with the alarm lamp or the alarm buzzer, the alarm signal output unit 208 outputs a signal for giving notice of the abnormality to the alarm devices. In addition, in a case where the reader/writer 1 is connected to the aforementioned the host system, the alarm signal output unit 208 can also output the alarm signal to the host system. In this case, the display unit, the alarm lamp, the alarm buzzer and the host system are notified that an abnormality occurs in the antenna 4, so that the user can know malfunction of the antenna 4.

With the components of the reader/writer 1 of the first embodiment and the functions implemented by the components, the controller 2 can always receive one or more response signals of the RF tags when the antenna 4 operates normally. On the other hand, when the antenna does not operate normally, the controller 2 can receive no response signal. Accordingly, when performing the reading process, the controller 2 can determine that the antenna 4 does not operate normally (i) if the number of response signals acquired in response to a read signal is zero. In addition, the controller 2 can determine that the RF tag 10 other than the operation confirmation RF tag 6 does not exist in the readable area of the reader/writer 1 (ii) if the number of response signals is one. Moreover, the controller 2 can determine that the article management RF tag 10 existing in the readable area is detected in addition to the operation confirmation RF tag 6 (iii) if the number of response signals is at least two.

Accordingly, the reader/writer 1 of the first embodiment is capable of surely detecting an abnormality of the antenna 4 by discriminating between mere absence of the article management RF tag 10 in the readable area and an occurrence of trouble in the antenna 4.

Next, descriptions will be given of a flow of the operation confirmation process in which the reader/writer 1 of the first embodiment detects whether or not the antenna 4 operates normally.

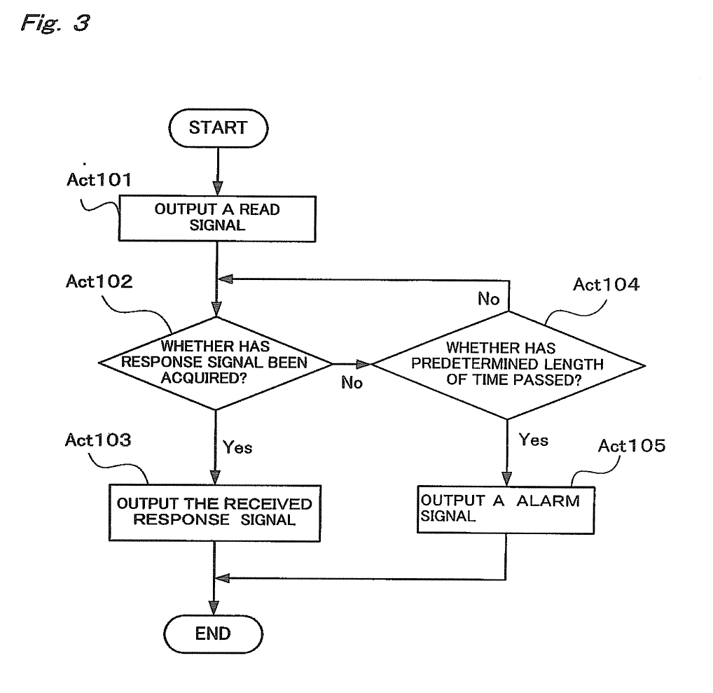

FIG. 3 is a flowchart showing the operation confirmation process for the antenna 4, which is executed by the reader/writer 1 of the first embodiment.

Firstly, in Act 101, the transmitter 200 outputs a read signal for reading the RF tag 10 from the antenna 4.

Next, in Act 102, the determination unit 206 determines whether or not the receiver 202 receives a response signal from the RF tag 10 and the operation confirmation RF tag 6 in response to the read signal.

In a case where that the determination unit 206 determines that the receiver 202 receives a response signal before the predetermined length of time passes (Yes in Act 102), the process proceeds to Act 103, and the output unit 204 outputs the received response signal to the memory 2b, the host system or the like.

On the other hand, in a case where a response signal is not received (No in Act 102), the process proceeds to Act 104, and the determination unit 206 determines whether or not the predetermined length of time has passed after the output of the read signal.

In a case where the determination unit 206 determines that the predetermined length of time has not passed (No in Act 104), the process returns to Act 102, and the determinations respectively of Act 102 and Act 104 are repeatedly executed.

On the other hand, in a case where the determination unit 206 determines that the predetermined length of time has passed (Yes in Act 104), the determination unit 206 notifies the alarm signal output unit 208 that an abnormality occurs in the antenna 4. Then, the alarm signal output unit 208 outputs a signal for giving notice of the abnormality of the antenna 4 to the display unit, the alarm lamp and the alarm buzzer of the reader/writer 1, or the host system or the like, and then causes each of the devices to give notice of the abnormality.

What has been described above is the flow of the operation confirmation process in which the reader/writer 1 of the first embodiment detects whether or not the antenna 4 operates normally. Note that, in a case where the determination unit 206 determines that at least one response signal is received within the predetermined length of time, the operation confirmation process does not have to be further performed continuously after the receipt of the response signal. That is because the reception means that the antenna 4 operates normally.

Through the process described above, it is possible to correctly discriminate between the absence of the article management RF tag 10 in the readable area of the reader/writer 1 and the failure in normal operation of the antenna 4. Then, in a case where the antenna 4 does not operate normally, it is possible to surely detect the abnormality of the antenna 4 and then to giving notice of the abnormality.

Note that the predetermined length of time, which serves as the basis for determining whether or not the antenna 4 is normal, can be set up optionally. For example, in a case where the user operates the reader/writer 1 for the read signal to be transmitted at an optional timing, it is possible to determine whether or not the antenna 4 is abnormal by determining whether or not one or more response signals are received until the optionally-set seconds pass after the read signal is transmitted. In addition, in a case where the reader/writer 1 is of a type which continuously transmits the radio waves, a length of time in which a response signal is intended to be received each time one read signal is transmitted may be set up as the predetermined length of time. In this case, the abnormal state of the antenna 4 can be determined by determining whether or not one or more response signals are received within the length of time.

In addition, in the first embodiment, the controller 2 has been described as an apparatus included in the reader/writer 1, but the controller 2 is not limited to this. A general-purpose computer or the like may be used as the controller 2. Such a computer can similarly implement the functions of the reader/writer 1 capable of executing the operation confirmation of the antenna 4, for example, by: storing programs for the process of reading RF tags and the operation confirmation process for the antenna 4 in the memory 2b of the computer; and causing a CPU of the computer to execute the programs.

Moreover, in the first embodiment, each of the RF tags has been described as a passive tag, but the RF tag is not limited to this. The operation confirmation process can be similarly performed by use of an RF tag of a system in which the RF tag itself emits radio waves (active tag system).

Furthermore, in the first embodiment, the operation confirmation process for the antenna 4 is performed in parallel with the process of reading the article management RF tag 10, but the operation confirmation process is not limited to this. Whether or not the antenna 4 operates normally may be determined by transmitting the read signal only for the purpose of performing the operation confirmation process for the antenna 4.

### Second Embodiment

Next, a second embodiment will be described.

A reader/writer 1A of the second embodiment sets the ID information of the operation confirmation RF tag 6 in distinction from the ID information of the other article management RF tags 10. Then, in a case where the response signal from the operation confirmation RF tag 6 is not acquired during the operation confirmation process, the reader/writer 1A determines that the antenna 4 is abnormal. The second embodiment is different from the first embodiment in that: the first embodiment causes a determination to be made on an abnormality of the antenna 4 on the basis of whether the number of response signals in response to the read signal is zero or at least one; and on the contrary, this second embodiment causes a determination to be made on an abnormality of the antenna, by using the ID information of the operation confirmation RF tag 6, on the basis of whether or not the response signal from the operation confirmation RF tag 6 is received. The reader/writer 1A of the second embodiment will be described hereinafter. The same reference numerals are used to denote the same components as those of the first embodiment. In addition, the descriptions of the same components are omitted herein.

The system configuration of the reader/writer 1A of the second embodiment is the same as that of the first embodiment, but unique ID information of the operation confirmation RF tag 6 is stored in the memory 2b. The unique ID information is used for a determination unit 206A to identify a response signal from the operation confirmation RF tag 6.

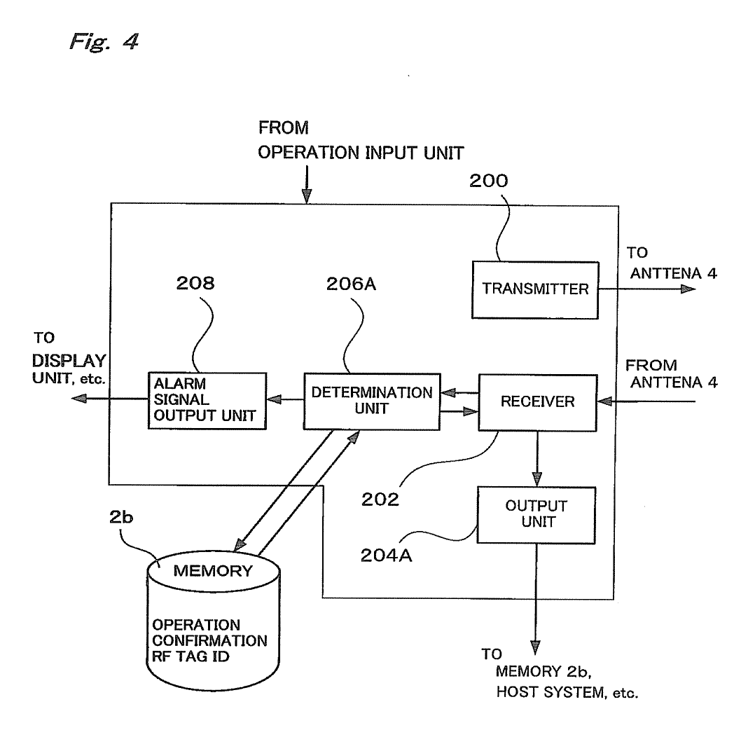

Next, the functions to be implemented by the reader/writer 1A of the second embodiment will be described. FIG. 4 is a functional block diagram to describe the functions of the reader/writer 1A of the second embodiment.

The transmitter 200 and the receiver 202 are the same as those of the first embodiment.

As in the case of the first embodiment, the determination unit 206A determines whether or not the receiver 202 receives a response signal within a predetermined length of time after the transmitter 200 transmits a read signal. In addition, in a case where the receiver 202 receives a response signal, the determination unit 206A determines whether or not the ID information included in the response signal matches the ID information of the operation confirmation RF tag 6, which is previously stored in the memory 2b.

In a case where the determination unit 206A determines that a response signal including the ID information corresponding to the operation confirmation RF tag 6 is not received within the predetermined length of time, the determination unit 206A determines that the antenna 4 does not operate normally. In this case, the alarm signal output unit 208 outputs a signal for causing the display unit or the host system to give notice of the abnormality of the antenna 4.

An output unit 204A outputs information, which is included in the response signal acquired by the receiver 202, to the memory 2b of the reader/writer 1A, or the host system. Furthermore, the output unit 204A is capable of outputting the response signal from the operation confirmation RF tag 6 in distinction from the response signal from the article management RF tag 10. Specifically, the ID information of the operation confirmation RF tag 6 and the ID information of the article management RF tag 10 can be discriminated from each other in the determination unit 206A, so that the acquired information of the operation confirmation RF tag 6 can be outputted to a destination different from the output destination of the information of the RF tag 10.

For example, in a case where the article management RF tag 10 and the operation confirmation RF tag 6 are stored in different databases, respectively, a signal from the operation confirmation RF tag 6 can be stored in a corresponding one of the databases.

In addition, in a case where the reader/writer 1A transmits a response signal to the host system managing RF tag information, the reader/writer 1A can transmit only a reading signal from the operation confirmation RF tag 10 to the host system by filtering out a read signal from the operation confirmation RF tag 6. The aforementioned process is performed for the following reasons. In a case where the an existing host system in which the information of the operation confirmation RF tag 6 is not registered, and which thus cannot discriminate the operation confirmation RF tag 6 from the other RF tags 10 is used as the host system, the information of the operation confirmation RF tag 6 may be registered without being discriminated from the information of the normal RF tags 10 when the information of the operation confirmation RF tag 6 is transmitted from the reader/writer 1A. The process prevents this registration, and also prevents an error that may occur since the information of the operation confirmation RF tag 6 is unregistered in the aforementioned case.

Note that whether or not the antenna 4 operates normally may be managed by outputting the information of the operation confirmation RF tag 6 to a different abnormality management system that is configured to manage the operation of the antenna 4.

The reader/writer 1A of the second embodiment described above brings about the following effect in addition to the effects of the reader/writer 1A of the first embodiment. The effect brought about by the reader/writer 1A is that the information of the operation confirmation RF tag 6 and the information of the article management RF tag 10 can be managed while the response signals from the operation confirmation RF tag 6 and the article management RF tag 10 are discriminated from each other. Accordingly, the host system managing the RF tag information need not respond to the operation confirmation process of the reader/writer 1A. In addition, the reader/writer 1A can be used, as it is, with the existing host system.

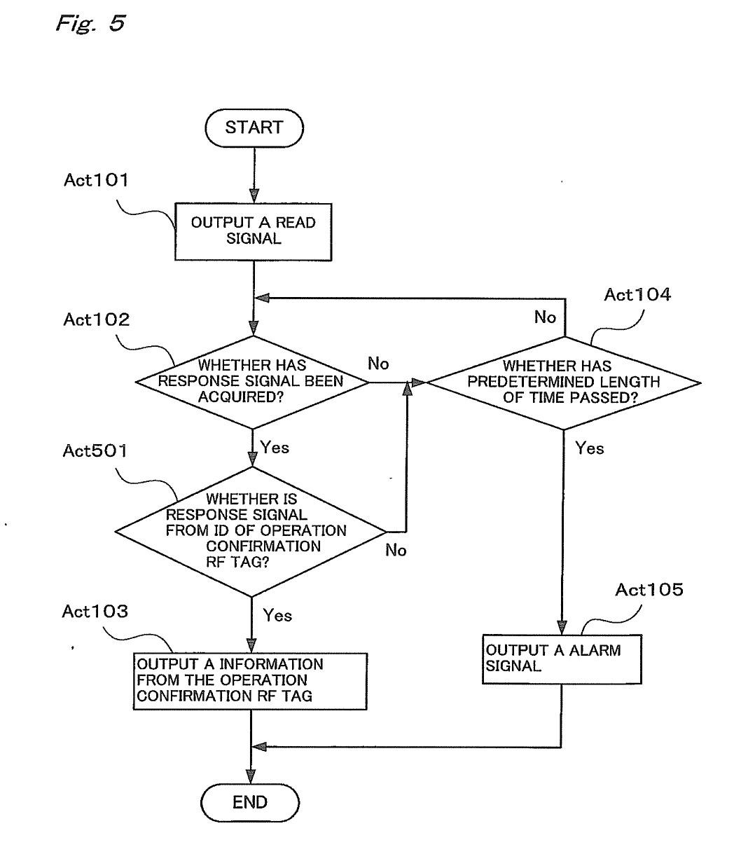

Next, a flow of the operation confirmation process of the second embodiment will be described. FIG. 5 is a flowchart showing the operation confirmation process for the antenna 4 to be executed by the reader/writer 1A of the second embodiment.

Firstly, the transmitter 200 outputs a read signal to the RF tags 6, 10 in Act 101. Next, in Act 102, the determination unit 206A whether or not a response signal is acquired from the RF tags 6, 10.

Next, in a case where a response signal is acquired (Yes in Act 102), the process proceeds to Act 501. The determination unit 206A refers to the ID information stored in the memory 2b, and then determines whether or not the ID information included in the response signal matches the ID information of the operation confirmation RF tag 6.

In a case where the determination unit 206A determines that the ID information matches the ID information of the operation confirmation RF tag 6 (Yes in Act 501), the process proceeds to Act 103, and the output unit 204A performs a predetermined output process. For example, the output unit 204A stores the acquired information from the operation confirmation RF tag 6 in the memory 2b of the reader/writer 1A in distinction from the information of the RF tag 10. In addition, the output unit 204A outputs the information of the operation confirmation RF tag 6 to the host system corresponding to the operation confirmation process, or a different abnormality management system.

On the other hand, in a case where a response signal is not acquired (No in Act 102), the process proceeds to Act 104, and the determination unit 206A determines whether or not a predetermined length of time has passed since the output of the read signal. In a case where the predetermined length of time has not passed, the process returns to Act 102, and the process is repeated. In a case where the predetermined length of time has passed, the process proceeds to Act 105, and the alarm signal output unit 208, which receives an abnormality occurrence signal from the determination unit 206A, outputs a signal for giving notice of an abnormality of the antenna 4 to the aforementioned devices configured to give notice. The user can be thereby notified of the malfunction of the antenna 4.

In addition, in a case where the determination unit 206A determines that the ID information included in the response signal does not match the ID information of the operation confirmation RF tag 6 (No in Act 501), the process proceeds to Act 104, and the determination unit 206A determines whether or not the predetermined length of time has passed. The process performed in Act 104 is the same as the aforementioned process.

Note that, in Act 501, even in a case where the determination unit 206A determines that the response signal is not a response signal from the operation confirmation RF tag 6 but a response signal from the article management RF tag 10, it can be said that the antenna 4 operates normally since the response signal is received. In this case, the determination unit 206A may determine that the antenna 4 operates normally, without waiting for the response signal to be acquired from the operation confirmation RF tag 6.

In addition, in Act 501 described above, in a case where a response signal from the article management RF tag 10 is received, the response signal of the RF tag 10 is outputted from the output unit 204A to the memory 2b or the like by an article management process different from this operation confirmation process.

Through the process described above, it is possible to correctly discriminate between absence of an article management RF tag 10 in the readable area of the reader/writer 1A and an abnormal operation of the antenna 4. In addition, in a case where the antenna 4 does not operate normally, the abnormality of the antenna 4 can be surely detected and then notified to the user.

### Third Embodiment

Next, a third embodiment will be described.

In the third embodiment, the aforementioned operation confirmation process is performed in a case where multiple antennas are connected to the controller 2 of a reader/writer 1B. The reader/writer 1B of the third embodiment stores the ID information of the operation confirmation RF tag 6 in the memory 2b as in the case of the reader/writer 1A of the second embodiment. Moreover, the reader/writer 1B determines whether or not the ID information of the acquired response signal matches the ID information of the operation confirmation RF tag 6 previously stored in the memory 2b. The third embodiment is different from the second embodiment in that whether or not response signals are respectively acquired from the operation confirmation RF tags attached to all of the antennas is determined because the operation confirmation RF tags are connected to the multiple antennas, respectively, in the third embodiment.

Hereinafter, the reader/writer 1B of the third embodiment will be described. Note that, in the description of the third embodiment, the reader/writer 1B will be described with an assumption that the reader/writer 1B has three antennas 4A, 4B and 4C. The number of antennas is not limited to this, however, and the reader/writer 1B can be provided with any number of antennas. Furthermore, the same reference numerals are used to denote the same components as those in the already-described the first and second embodiments, and the descriptions of the components are omitted herein.

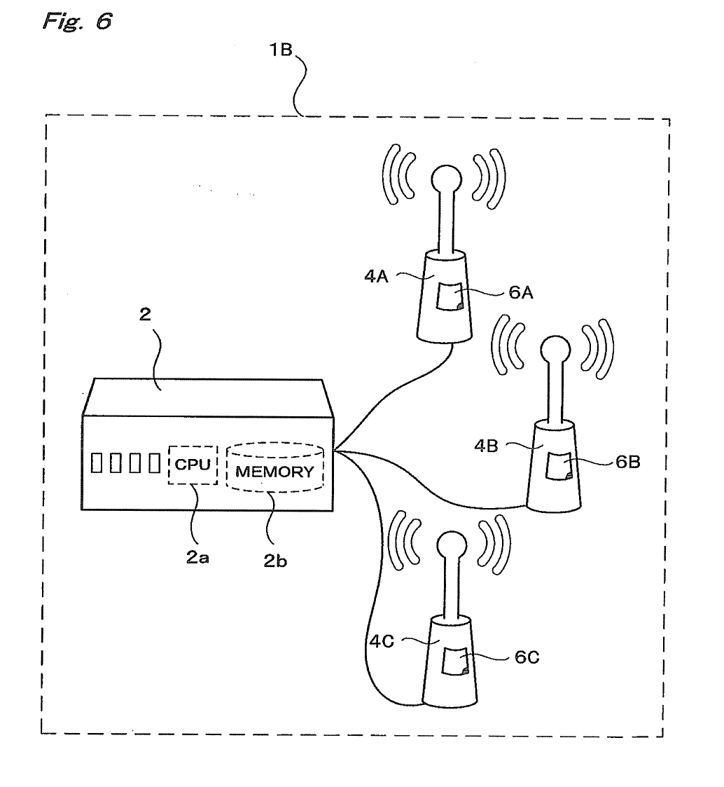

FIG. 6 is a system diagram showing a configuration of the reader/writer 1B of the third embodiment. As shown in FIG. 6, the reader/writer 1B of the third embodiment is provided with the multiple antennas 4A, 4B and 4C connected the controller 2. The antennas 4A, 4B and 4C include operation confirmation RF tags 6A, 6B and 6C, respectively. Each of the RF tags 6A, 6B and 6C has different ID information.

Then, the controller 2 outputs a read signal from each of the antennas 4A, 4B, 4C to RF tags, and determines whether or not the response signals are acquired by all of the antennas 4A to 4C within a predetermined length of time. If there exists a signal of an operation confirmation RF tag, which is not acquired, the controller 2 specifies the ID information of the signal. In this manner, even in a case where multiple antennas are connected to the controller 2, an antenna that does not operate normally can be specified. Then, in a case where it is determined that the antenna 6B does not operate normally, for example, the aforementioned alarm units can notify the user of the result of the determination.

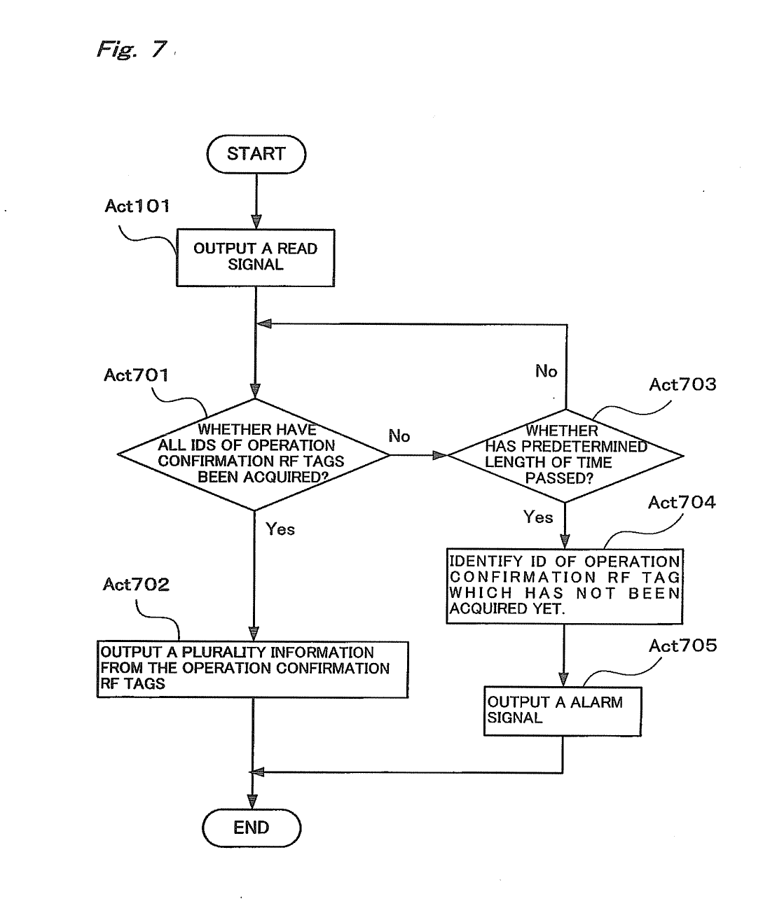

A flow of the operation confirmation process to be executed by the reader/writer 1B of the third embodiment will be described with reference to FIG. 7. FIG. 7 is a flowchart showing the operation confirmation process for the antennas 4A to 4C of the third embodiment. Note that, because the functional blocks performing each process are the same as the functional blocks shown in FIG. 4, the description will be given with reference to FIG. 4 as well.

In Act 101, the transmitter 200 outputs a read signal to the RF tags 6A to 6C and RF tag 10.

In Act 701, the determination unit 206A determines whether or not the receiver 202 connected to the antennas 4A to 4C acquires all of the response signals from the operation confirmation RF tags 6A to 6C. Specifically, the determination unit 206A determines whether or not the ID information of the response signals acquired via the antennas 4A to 4C match the ID information of the operation confirmation RF tags 6A to 6C, which are previously stored in the memory 2b. The determination unit 206A determines whether or not all of the ID information of the operation confirmation RF tags 6A to 6C is acquired.

In a case where the determination unit 206A determines that the response signals of all of the operation confirmation RF tags 6A to 6C are acquired (Yes in Act 701), the process proceeds to Act 702, and the same predetermined output process as those of the first and second embodiments are performed on the information acquired from the operation confirmation RF tags 6A to 6C.

On the other hand, in a case where the determination unit 206A determines that the response signals of all of the operation confirmation RF tags 6A to 6C are not acquired (No in Act 701), the process proceeds to Act 703, and the determination unit 206A whether or not a predetermined length of time has passed. If the predetermined length of time has not passed, the process returns to Act 701.

In a case where the determination unit 206A determines that the predetermined length of time has passed (Yes in Act 703), the process proceeds to Act 704, and the determination unit 206A compares the ID information of the acquired response signals with the ID information of the operation confirmation RF tags 6A to 6C stored in the memory 2b, and thus specifies the ID information of the operation confirmation RF tag whose response signal is not acquired.

The process then proceeds to Act 705. On the basis of the ID information of the operation confirmation RF tag whose response signal is not acquired, and which is outputted from the determination unit 206A, the alarm signal output unit 208 outputs a signal for giving notice of an abnormality of the antenna, which corresponds to the operation confirmation RF tag, to the aforementioned devices configured to perform notification. The alarm signal output unit 208 then performs the predetermined output process. For example, in a case where the response signal from the operation confirmation RF tag 6B is not acquired, the determination unit 206A determines that the antenna 4B does not operate normally. According to the determination, the alarm signal output unit 208 outputs a signal for giving notice that the antenna 4B does not operate normally to the display unit and other alarm units.

The process flow described above is the flow of the operation confirmation process to be executed by the reader/writer 1B of the third embodiment to confirm whether or not multiple antennas operate normally.

The above-described reader/writer 1B of the third embodiment is capable of discriminating between the absence of an article management RF tag 10 in the readable area and the abnormal operation of an antenna, even in a case where the reader/writer 1B is provided with multiple antennas. Furthermore, in a case where an antenna does not operate normally, the reader/writer 1B is capable of specifying which antenna is abnormal, and then of notifying the user of the abnormality of the antenna.

Note that, in a case where a different antenna exists in the readable area of each of the antennas, there may be a case where reflected radio waves are received not only from the operation confirmation RF tag attached to the antenna itself, but also from the operation confirmation RF tag of the different antenna in the same readable area. For example, in a case where the antenna 4A receives reflected waves from the operation confirmation RF tag 6B of the antenna 4B while the antenna 4B fails, the receiver 202 acquires a response signal from the operation confirmation RF tag 6B of the antenna 4B which is supposed to fail. In this case, the determination unit 206A determines that the antenna 4B does not fail.

Accordingly, in a case where the reader/writer 1B is provided with the multiple antennas 4A to 4C, the operation confirmation RF tags 6A to 6C need to be disposed in a state where each of the RF tags 6A to 6C is capable of communicating with only a corresponding one of the antennas. In this case, a shield that blocks radio waves in order for each of the operation confirmation RF tags to be surely detected by a corresponding one of the antennas, but not to be detected by the other antennas is attached to each of the operation confirmation RF tags. With this shield, each of the antennas can detect only a corresponding one of the operation confirmation RF tags, so that the antenna no longer detects the operation confirmation RF tags of the other antennas.

Note that, although each of the aforementioned embodiments has been described with an assumption that one operation confirmation RF tag 6 is provided to each antenna 4, the invention is not limited to this case, and multiple operation confirmation RF tags 6 may be provided to each antenna 4. The attachment of multiple operation confirmation RF tags to each antenna 4 enables the operation confirmation process to be performed on a more secure basis.

In addition, in each of the aforementioned embodiments, it is determined that the antenna 4 operates normally when the response signal from the operation confirmation RF tag 6 is acquired once in a predetermined length of time. However, the invention is not limited to this. For example, it may be determined that the antenna 4 operates normally in a case where: the controller 2 of the reader/writer 1 outputs the read signal multiple times; and the response signal from the operation confirmation RF tag 6 can be acquired multiple times. Moreover, when it is determined through the operation confirmation process that an antenna 4 does not operate normally, it may be finally determined that an abnormality occurs in the antenna 4 only after: the operation confirmation process is further performed repeatedly; and it is still determined that the antenna 4 does not operate normally. In any of the aforementioned cases, the operation state of the antenna 4 can be more surely confirmed because the operation confirmation process is performed multiple times.

Moreover, each of the aforementioned embodiments has been described with an assumption that each antenna 4 is provided with the operation confirmation RF tag 6. However, the invention is not limited to this. The operation confirmation RF tag 6 may be provided at a place where: the radio waves from the antenna 4 are always receivable; and also reflected waves can be transmitted to the antenna 4. For example, the operation confirmation RF tag 6 may be disposed independently of the antenna 4 in a posture and a positional relationship which ensure that: the radio waves from the antenna 4 can be received by the operation confirmation RF tag 6; and the reflected radio waves are received by the antenna 4.

Furthermore, a program to cause each of the aforementioned operations to be executed in a computer constituting one of the aforementioned reader/writers 1, 1A, 1B in the respective embodiments may be provided as an antenna operation confirmation program. In each of the aforementioned embodiments, a case where the program to implement the functions of carrying out the invention is previously recorded in the memory provided inside the apparatus is exemplified. However, the invention is not limited to this. The same program may be downloaded from a network to the apparatus. Otherwise, the same program, which is recorded in a computer readable recording medium, may be installed in the apparatus. Any type of recording medium may be used as the recording medium, as long as the recording medium is a computer readable recording medium in which the program can be stored.

Specifically, examples of the recording medium include: an internal memory device implemented inside a computer, such as a ROM and RAM; a portable storage medium such as a CD-ROM, a flexible disk, a DVD disc, an optical magnetic disk and an IC card; a database to retain a computer program; another computer and a database of the computer; and a transmission medium on a communication line. In addition, the functions acquired through the previous installation or downloading as described above may be functions that are implemented in cooperation with an OS (operating system) in the apparatus.

Note that, a part or entirety of the program may be an execution module, which is dynamically generated.

The invention can be carried out in various forms without departing from the spirit or the main characteristics of the invention. For this reason, the aforementioned embodiments are shown as examples only in various aspects, and shall not be construed as limiting the scope of the invention. The scope of the invention is indicated by the scope of claims, and is not limited by the contents of the specification. Furthermore, all variations, various improvements, alternatives and modifications, that belong to the equivalent range of the scope of claims, are within the scope of the invention.

What is claimed is:

1. A communication system comprising:
an antenna configured to transmit and receive radio waves for wireless communication with an first RF tag attached to a management target article;
an second RF tag disposed within a communication coverage area in a state of being allowed to communicate with the antenna;
a transmitter configured to transmit a read signal for reading information of the RF tag to the first and the second RF tags via the antenna; and
a determination unit configured to determine a malfunction of the antenna, when not receiving the reply signal from the first RF tag and second RF tag in response to the read signal.

2. The communication system according to claim 1, wherein the second RF tag is disposed integrally with the antenna.

3. A communication system comprising:
an antenna configured to transmit and receive radio waves for wireless communication with an first RF tag attached to a management target article;
an second RF tag having unique ID information disposed within a communication coverage area in a state of being allowed to communicate with the antenna.
a transmitter configured to transmit a read signal for reading information of the RF tag to the first and second RF tags via the antenna; and
a determination unit configured to determine a malfunction of the antenna, when the antenna does not received the unique ID information from the second RF tag in response to the read signal.

4. A communication system according to claim 3, wherein
the antenna consists a plurality of antennas; and
the second RF tag consists a plurality of tags with unique ID information which is different corresponding to the antennas;

5. The communication system according to claim 3, wherein the second RF tag is disposed integrally with the antenna.

6. An operation confirmation processing method for a communication system including an first RF tag attached to a management target article, and an antenna configured to transmit and receive radio waves for wireless communication with the first RF tag, the method comprising:
transmitting a read signal for reading information of the RF tag to the first RF tag and an second RF tag via the antenna, the second RF tag is attached to the area which can communicate with the antenna; and
determining the antenna malfunction, when not receiving the reply signal from the first RF tag and second RF tag in response to the read signal.

7. An operation confirmation processing method for a communication system including an first RF tag attached to a management target article, and an antenna configured to transmit and receive radio waves for wireless communication with the first RF tag, the method comprising:
transmitting a read signal for reading information of the RF tag to the first RF tag and an second RF tag via the antenna, the second RF tag having unique ID information attached to the area which can communicate with the antenna; and
determining the antenna malfunction, when the antenna does not received the unique ID information from the second RF tag in response to the read signal.

8. An operation confirmation processing method for a communication system including an first RF tag attached to a management target article, and a plurality of antennas each configured to transmit and receive radio waves for wireless communication with the first RF tag, the method comprising:
transmitting a read signal for reading information of the RF tag to the RF tag and an plurality of operation confirmation RF tags via the plurality of antennas, the plurality of second RF tags each having unique ID information attached to the plurality areas which can communicate with corresponding to the plurality of the antenna; and
transmitting a read signal for reading information of the RF tag to the RF tag and an plurality of operation confirmation RF tags via the plurality of antennas, the plurality of second RF tags each having unique ID information attached to the plurality areas which can communicate with corresponding to the plurality of the antenna; and
determining the antenna malfunction, when the plurality of antennas does not received the plurality unique ID information from at least the second RF tags in response to the read signal.
